(19) United States
(12) Patent Application Publication
(10) Pub. No.: US 2016/0364591 A1
(43) Pub. Date: Dec. 15, 2016

(54) Fingerprint Sensing Access for Security and Personalization in Apps and Devices

(71) Applicant: Cypress Semiconductor Corporation, San Jose, CA (US)

(72) Inventors: Hassane El-Khoury, Pleasanton, CA (US); Erhan Hancioglu, Bothell, WA (US); Onur Ozbek, Kirkland, WA (US); Andrew C. Page, Kirkland, WA (US); Patrick N. Prendergast, Clinton, WA (US); Jaskarn Singh Johal, Mukilteo, WA (US)

(21) Appl. No.: 14/866,168

(22) Filed: Sep. 25, 2015

Related U.S. Application Data
(60) Provisional application No. 62/175,976, filed on Jun. 15, 2015.

(51) Int. Cl. G06K 9/00; G06F 21/32; G06F 3/0481; G06F 3/0488; G06F 3/044; G06F 3/041

(52) U.S. Cl. CPC G06K 9/0002; G06F 3/044; G06F 3/0416; G06K 9/00087; G06F 3/04817; G06F 3/04883; G06F 21/32

(57) ABSTRACT

A user interface with fingerprint recognition and secure access to sensitive information and applications is described. Fingerprint recognition may occur on a dedicated module or integrated into a touchscreen. The user interface may be configured to display icons representative of secure applications and gate access thereto via biometric authentication or the user interface may be configured to display icons representative of secure applications only upon detection of valid biometric data.

### RELATED APPLICATION

This patent application claims the benefit of U.S. Provisional Patent Application No. 62/175,976, filed Jun. 15, 2015, which is incorporated by reference herein.

### TECHNICAL FIELD

The present disclosure relates generally to fingerprint sensing, and more particularly to the construction and use of a fingerprint sensing array.

### BACKGROUND

User devices store various types of information and allow access to additional information through their connection to the internet and databases stored thereon. Gaining unauthorized access to a user's device may provide access to confidential information about that user that could be used to do harm, steal identity, or commit other types of fraud.

Biometric authentication is one method by which the owner of a device may ensure that their information remains private when necessary and that access to information and systems remains proprietary.

### SUMMARY

A method for accessing a secure function id disclosed. The method for access the secure function may include detecting a finger on a fingerprint data generation device and generating data representative of the fingerprint. The data may then be compared to a library of data corresponding to stored fingerprints in a memory and if the generated data matches on of the library of data, an icon representative of the secure function may be displayed. A location of a finger or other conductive object on a touch-sensitive panel may then be determined and if location corresponds to locations for the displayed icon, the secure function may be executed.

A method for operating a touch-sensitive device is disclosed. The method includes scanning an array of electrodes over a display in a first mode configured to detect the position or proximity of a conductive object on the or to the array. The method also includes scanning another array of electrodes in a second mode configured to generate an image or data representative of a fingerprint on the other array. The position/proximity array and the fingerprint array may share at least one electrode, they may be separate, or they may be integrated and intermixed in various embodiments.

A biometric authentication device is disclosed. The biometric authentication device may include electrodes disposed over a display element and configured to detect the presence and determine the location of a conductive object over the display and to execute functions based on the location of the conductive object. The biometric authentication device may also include other electrodes disposed over the array and configured to generate data representative of a fingerprint. The electrodes configured to generate data representative of a fingerprint may only partially cover the display, resulting in incomplete data representative of fingerprints. The biometric authentication device may stitch together multiple data sets to create a single data set representative of a fingerprint.

### DESCRIPTION OF THE DRAWINGS

FIG. 1 illustrates a user device with biometric authentication according to various embodiments.

FIG. 2 illustrates a system with a touch detection module and biometric authentication module according to one embodiment.

FIG. 3A illustrates a user interface with biometric authentication for secure applications that are not displayed without authentication according to one embodiment.

FIG. 3B illustrates a user interface with biometric authentication for secure applications that are displayed but not accessible without authentication according to one embodiment.

FIG. 3C illustrates a user interface with biometric authentication for a page secure applications that are visible but not accessible without authentication according to one embodiment.

FIG. 4 illustrates a secondary authentication according to one embodiment.

FIG. 5 illustrates a method for accessing secure applications through biometric authentication according to one embodiment.

FIG. 6 illustrates a method for accessing a user device with biometric authentication according to one embodiment.

FIG. 7 illustrates a method for accessing secure applications through biometric authentication according to one embodiment.

FIG. 8 illustrates integrated touch detection electrodes and fingerprint imaging electrodes according to one embodiment.

FIG. 9 illustrates a user device with integrated touch detection electrodes and fingerprint imaging electrodes according to one embodiment.

FIG. 10 illustrates a method for accessing a user device with integrated touch detection electrodes and fingerprint imaging electrodes according to one embodiment.

FIG. 11A illustrates a user device display with on-screen biometric authentication according to one embodiment.

FIG. 11B illustrates a user device with fingerprint imaging electrodes for on-screen biometric authentication according to one embodiment.

FIG. 11C illustrates a user device with integrated touch detection electrodes and fingerprint imaging electrodes for on-screen biometric authentication according to one embodiment.

FIG. 11D illustrates a user device with integrated touch detection electrodes and fingerprint imaging electrodes for on-screen biometric authentication for a page of secure applications according to one embodiment.

FIG. 11E illustrates a user device with integrated touch detection electrodes and fingerprint imaging electrodes for on-screen biometric authentication for a page of secure applications according to one embodiment.

FIG. 11F illustrates a user device with integrated touch detection electrodes and fingerprint imaging electrodes for on-screen biometric authentication for a mixture of non-secure applications and secure applications according to one embodiment.

FIG. 12 illustrate a user device with dual authentication according to one embodiment.

FIG. 13A illustrates a user device with a partially populated panel of fingerprint imaging electrodes according to one embodiment.

FIG. 13B illustrates example spacing of partially populated fingerprint imaging electrodes and touch detection electrodes according to one embodiment.

FIG. 13C illustrates a fingerprint image reconstructed from a partially populated panel according to one embodiment.

FIG. 14A illustrates a user device with biometric confirmation of secure actions in applications according to one embodiment.

FIG. 14B illustrates a user device with on-screen biometric confirmation of secure actions in an applications according to one embodiment.

### DETAILED DESCRIPTION

In the following description, for purposes of explanation, numerous specific details are set forth in order to provide a thorough understanding of the embodiments of the present invention discussed herein. It will be evident, however, to one skilled in the art that these and other embodiments may be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment.

For simplicity and clarity of illustration, reference numerals may be repeated among the figures to indicate corresponding or analogous elements. Numerous details are set forth to provide an understanding of the embodiments described herein. The examples may be practiced without these details. In other instances, well-known methods, procedures, and components are not described in detail to avoid obscuring the examples described. The description is not to be considered as limited to the scope of the examples described herein.

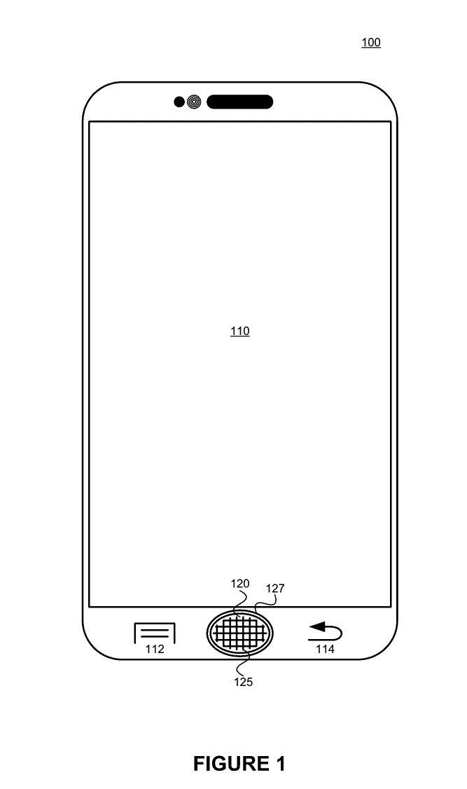

FIG. 1 illustrates one embodiment of a user device 100 with a fingerprint-enabled interface. User device 100 may include a touchscreen 110 configured to accept user interactions and manipulate displayed content on a graphical display (such as an LCD). Touchscreen 110 may operate by measuring capacitance on at least one of a plurality of touch detection electrodes disposed over the surface of a display. In other embodiments, touchscreen 110 may use resistance measurements to identify pressed locations. In still other embodiments, touchscreen may use other touch-enabling detection methods such as surface acoustic wave, force measurement, and optical sensing. Optical sensing may include infrared (IR) detection. User device 100 may also include discrete buttons 112 and 114 that may be assigned context-driven functions. Discrete buttons 112 and 114 may be assigned to fixed locations on user device 100. In various embodiments, discrete buttons 112 and 114 may be touch sensitive or mechanical.

User device 100 may also include a fingerprint detection module 120. Fingerprint detection module 120 may be a mechanical button on which is disposed a fingerprint detection array 125. In this embodiment, the fingerprint detection module 120 may be configured to wake user device 100 on mechanical actuation of fingerprint detection module 120 and to authenticate a user with fingerprint detection array 125. In another embodiment, fingerprint detection module 120 may be a touch-sensitive button located on the surface of user device 100. In this embodiment, fingerprint detection module 120 may poll the fingerprint detection array 125 periodically to detect a user action. In another embodiment, a separate touch-sensitive electrode 127 or sensor may be polled to detect a user presence over fingerprint detection array 125.

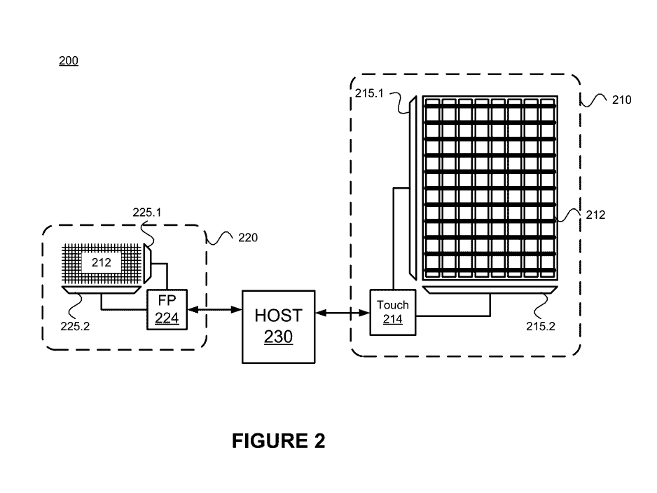

FIG. 2 illustrates an embodiment of a system 200 that includes a touch detection module 210 and a fingerprint imaging module 220. Touch detection module 210 may include an array 212 of touch detection electrodes that are disposed substantially over a user interface on a display (not shown). Touch detection electrodes of array 212 may be coupled to a touch controller 214 through multiplexors 215.1 and 215.2. Touch controller 214 may be configured to measure capacitance on and/or between the touch detection electrodes of array 212 and determine a location of a finger or other conductive object on array 212. The touch location may then be passed to host 230 for further processing and to control a user interface associated with array 212.

Fingerprint imaging module 220 may include an array 222 of fingerprint imaging electrodes that are disposed in a location accessible to a user's finger. Fingerprint imaging electrodes of array 222 may be coupled to a fingerprint controller 224 through multiplexors 225.1 and 225.2. Fingerprint controller 224 may be configured to measure capacitance on and/or between the fingerprint imaging electrodes of array 222 and construct an image of a fingerprint or a corresponding fingerprint data. In one embodiment, the fingerprint data may be representative of an image of a fingerprint, but not the image itself. Fingerprint data based on the fingerprint image may then be passed to host 230 for further processing and to match the fingerprint data to one of a library of stored fingerprint data corresponding to one or more fingerprint images. The library of stored fingerprints may be stored in a memory, which may be integrated with the fingerprint controller, the host, or as/in a separate circuit element.

In various embodiments, portions of system 200 may be integrated into different controllers. For example, touch controller 214 and fingerprint controller 224 may be on the same integrated circuit or the capacitance measurement portions of each controller may be on the same integrated circuit and the detection and imaging portions (logic) of each controller may be separate. In other embodiments, the array 212 and array 222 may be integrated into the same substrate or they may be separate. If arrays 212 and 222 are integrated into the same substrate, they may use the same electrodes, but be coupled to different controllers, or they may use different electrodes and be coupled to the same controller, as well as other permutations. All the digital processing may be executed on a single controller, like the host, or, in other embodiments, the processing may be distributed to different controllers in the system.

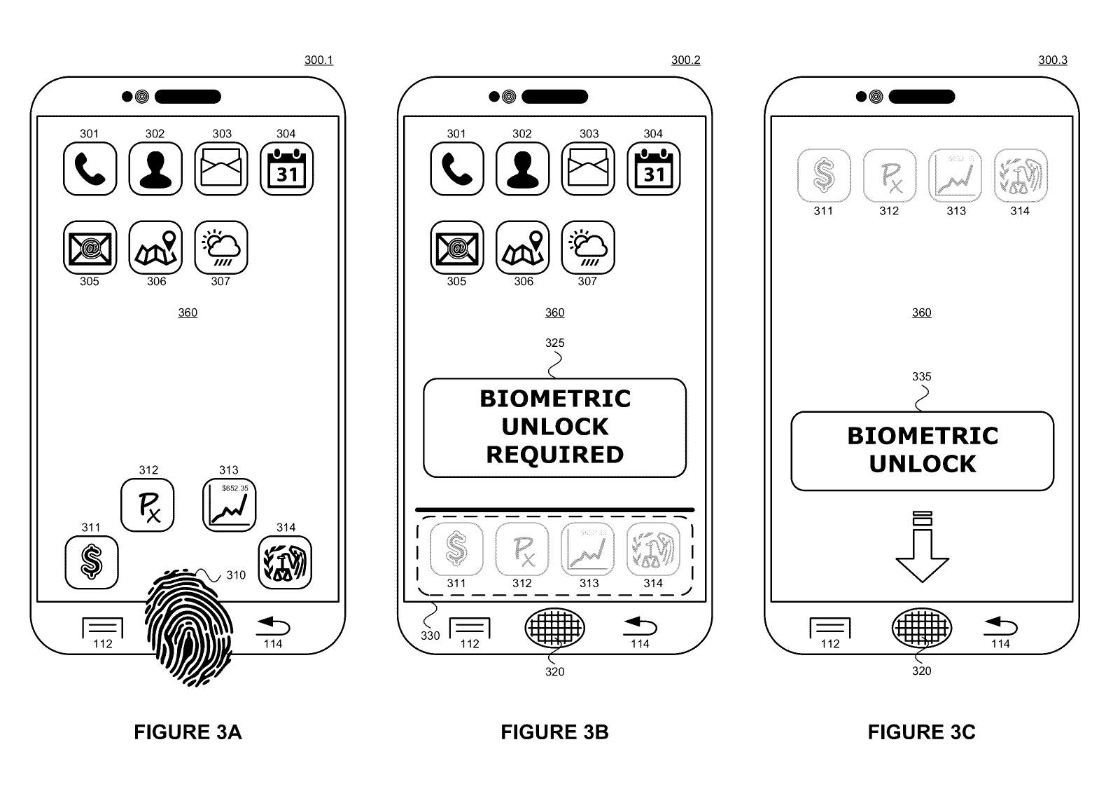

FIG. 3A illustrates one embodiment of a user device 300.1 with biometric security for a selection of functions in a user interface 360. While non-secure (e.g., “open”) applications may be displayed and accessed from the main portion of user interface 360, secure (e.g., “more sensitive”) applications may be restricted and accessed through contact with and authentication by a biometric sensor such as fingerprint detection module 120 of FIG. 1. In some embodiments, non-secure applications may relate to a telephone 301, a contact list 302, SMS messaging 303, a calendar 304, electronic mail (email) 305, maps 306, or weather 307. Secure applications may relate to banking 311, medical information or prescriptions 312, investments 313, and access to tax information 314. When a user places their finger over the biometric sensor, secure applications 311-314 may be displayed within user interface 360. In one embodiment, secure applications 311-314 may be displayed only if the fingerprint image 310 (or corresponding fingerprint data) matches one of a library of fingerprints (or fingerprint data) permitted to access secured information of the user device 300.1. In one embodiment, the restricted, secure applications 311-314 may not be displayed except when a user's finger is present on the biometric sensor. To select one of the secure applications 311-314, a user may move their finger from the biometric sensor to one of the secure applications 311-314. In one embodiment, to ensure user authentication, this movement may require constant contact with user device 300.1, whereby the user's finger travels from the biometric sensor to the location representing the secure application (such as secure applications 311-314) without leaving the surface of the user device. In another embodiment, there may be a period of time during which secure applications 311-314 remain visible and accessible to the user. After the period of time has elapsed and if the user has not selected a secure application, secure applications 311-314 may be hidden (or their display discontinued) and accessed again only through another contact with and authentication by the biometric sensor.

FIG. 3B illustrates another embodiment of a user device 300.2 with biometric security for a selection of functions in a user interface. In this embodiment, a list of secure applications 311-314 may be displayed in a region 330 of the user interface. While secure applications 311-314 may be visible, their operation may be gated by authentication provided by the biometric sensor 320. If a user places their finger on one of the secure applications 311-314, a prompt 325 may be displayed to alert the user that further action is required to access the desired secure application. The user may then place their finger on biometric sensor 320 for authentication. If fingerprint image (310 of FIG. 3A) or corresponding fingerprint data matches one of a library of fingerprints for fingerprint data, secure applications 311-314 may be made available to the user or may be entered based on the previously detected interaction with an icon corresponding to the secure application. In one embodiment, the secure applications 311-314 may be visibly distinct from non-secure applications 301-307. For example, secure applications 311-314 may appear to be semi-transparent, faded, or somehow grayed out until user authentication is complete. In another embodiment, secure applications 311-314 may have the same general appearance as non-secure applications 301-307, but may be in an area of the user interface set aside for secure applications 311-314, such as region 330. In still another embodiment, secure applications 311-314 may have the same general appearance as and be intermixed with non-secure applications 301-307. In this embodiment, the user may be notified of the requirement for authentication only after they attempt to execute a secure applications 311-314.

FIG. 3C illustrates another embodiment of a user device 300.3 with biometric security for a selection of functions in a user interface 360. In this embodiment, secure applications are accessible through a “secure page” provided by the user device that is a separate page from an “open page” (not shown) provided by the user device. Access to any application on a secure page is gated by biometric authentication. The secure page may be displayed but not accessible or it may be accessible only after authentication with biometric sensor 320. If the secure page is displayed, but access thereto gated by biometric authentication, a prompt 335 may be displayed to indicate to a user that authentication is required. Alternatively, no prompt may be displayed, but the secure applications 311-314 on the secure page may be otherwise indicated as secure. In one embodiment, the secure applications 311-314 may be semi-transparent or grayed out. Once the user has performed a successful biometric authentication, access to secure applications 311-314 may be permitted.

In some instances, biometric authentication may not be possible. Damage to a user's finger, a covering (such as a glove), or tolerance in the biometric authentication may cause a false negatives and inappropriate failures of biometric authentication may be output. In this case, a secondary authentication method may be used.

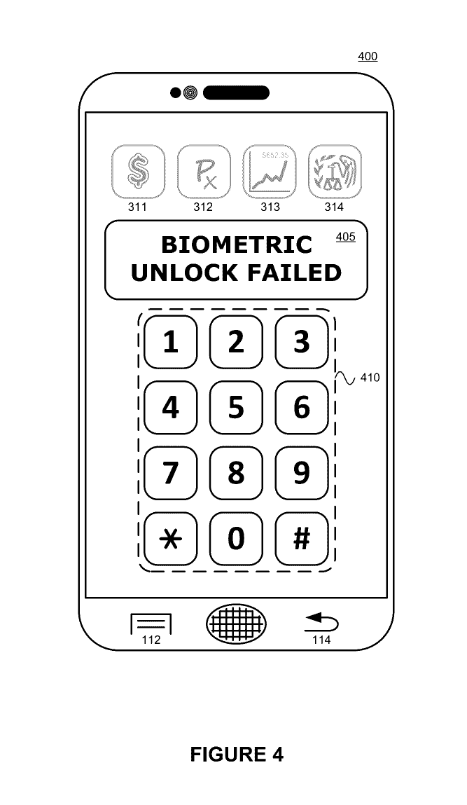

FIG. 4 illustrates a user device 400 with key entry authentication that may be displayed after a failed biometric authentication, indicated by message field 405. In this embodiment, a user may be given the opportunity to enter a key sequence to unlock the secure applications 311-314. While a number pad 410 is shown in this embodiment, a more complex keyboard may alternatively or additionally be presented to the user. In still other embodiments, non-touch authentication methods may be alternatively or additionally used, including audio or visual mechanisms, such as a passphrase spoken into a microphone of the user device or an image presented to the device. In one embodiment, the image may presented to the device's camera and may be a QR code or bar code.

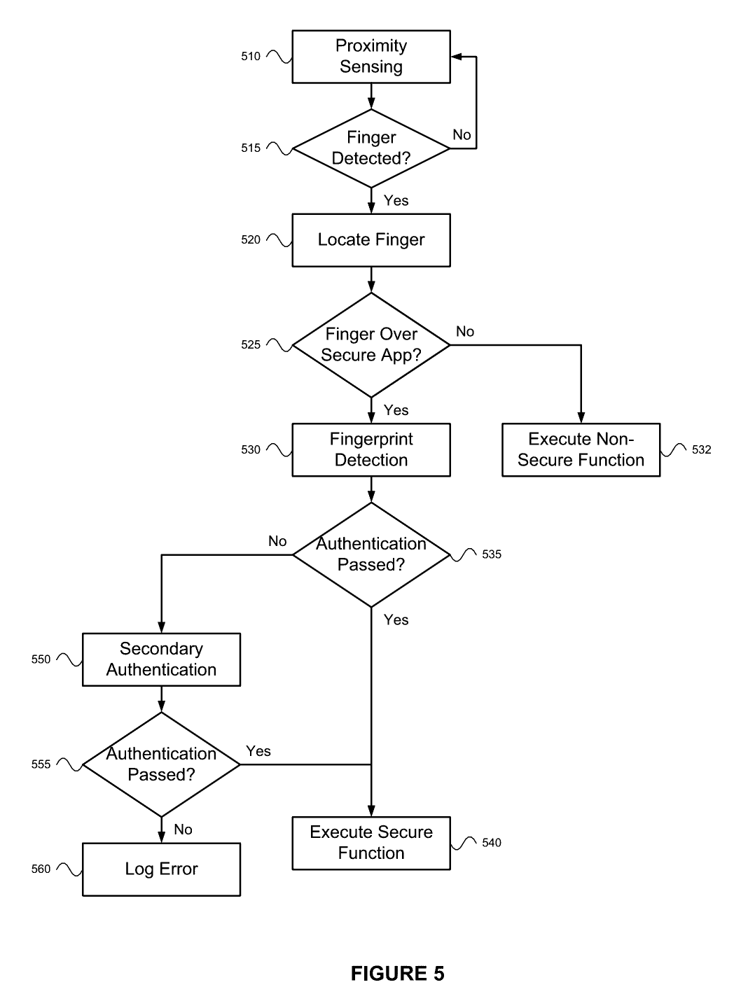

FIG. 5 illustrates a method 500 for executing a secure application according to the embodiments of FIGS. 3A-C and FIG. 4. A user may be detected in step 510 through a proximity sensing operation. The proximity sensing operation of step 510 may use touch detection electrodes that are part of the touchscreen or other proximity-optimized electrodes in various embodiments. If a finger (or other conductive or actuating element) is detected on or near the surface of the user device in step 515, the location of the finger or other object may be calculated in step 520. If no finger or other object is detected on or near the surface of the user device in step 515, the proximity sensing operation of step 510 may be repeated. After the location of the finger or other conductive object is calculated in step 520, the location may be compared with locations that correspond to the various applications, both non-secure and secure, in step 525. If the finger or conductive object is located at a location corresponding to a non-secure application, that non-secure application may be executed in step 532. If the finger or other conductive object is located over a location corresponding to a secure application, the user interface device may request a biometric authentication. In one embodiment, biometric authentication may require presentation of a fingerprint. The fingerprint may be detected in step 530. If the presented fingerprint matches one of the library of fingerprints in step 535, authentication may be passed and the secure application may be executed in step 540. If the biometric authentication of steps 530 and 535 fails and the detected fingerprint does not match on of the library of fingerprints, a secondary authentication may be presented in step 550. In one embodiment, the secondary authentication may be a key entry as illustrated in FIG. 4. In various other embodiments, alternate authentication methods may be implemented. While a keypad is discussed here (and illustrated in FIG. 4), a more complex keyboard may alternatively or additionally be presented to the user. In still other embodiments, non-touch authentication methods may be alternatively or additionally used, including audio or visual mechanisms, such as a passphrase spoken into a microphone of the user device or an image presented to the device. In one embodiment, the image may presented to the device's camera and may be a QR code or bar code. If the secondary authentication is passed in step 555, the secure application may be executed in step 540. If the secondary authentication fails in step 555, an error may be logged and the device may return to steps 510, 520, or 530.

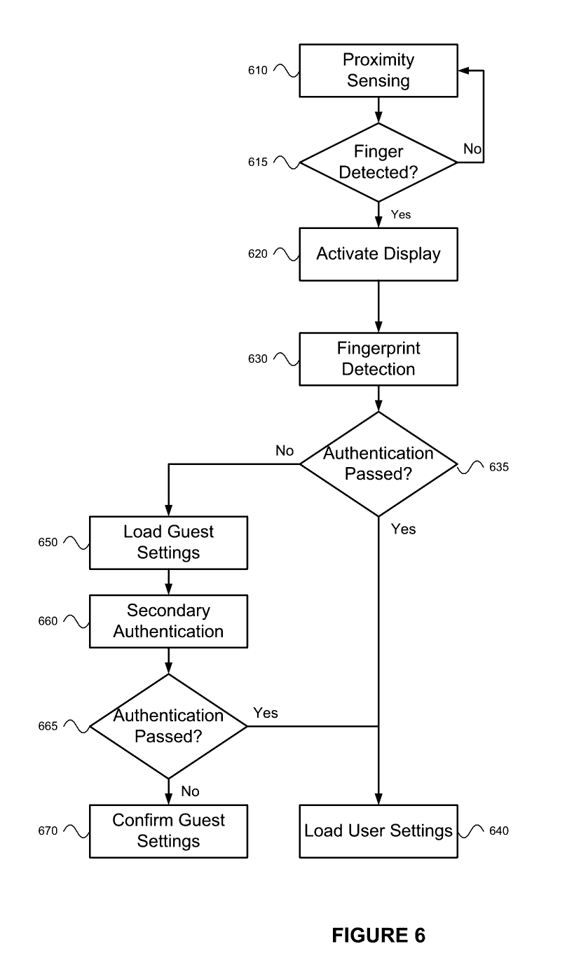

FIG. 6 illustrates a method 600 for executing a secure application according to the embodiments of FIGS. 3A-C and FIG. 4. A conductive object, such as a finger, may be detected in step 610 through a proximity sensing operation. The proximity sensing operation of step 610 may use sensors that are part of the touchscreen or other proximity-optimized sensors in various embodiments. If a finger (or other conductive or actuating element) is detected on or near the surface of the device in step 615, the display may be activated and the user interface presented to the user in step 620. Once the display is activated, the user interface may request the user to present a fingerprint for biometric authentication in step 630. If the presented fingerprint matches one of the library of fingerprints in step 635, authentication may be passed and the secure application may be executed in step 640. Comparison of fingerprint may be through a comparison of fingerprint data representative of or corresponding to a fingerprint image in one embodiment. In another embodiment, the image of the fingerprint itself may be compared to a library of fingerprints. If the biometric authentication of steps 630 and 635 fails and the detected fingerprint does not match one of the fingerprints in the library of fingerprints in a memory (or if fingerprint data does not match the library of fingerprint data), guest settings may be loaded in step 650. In one embodiment, the guest settings of step 650 may exclude access to secure applications and other confidential information of the user device. Additionally, guest settings may cause the user device to operate in a factory-defined mode, absent any customization and personalization configured by authorized users. A secondary authentication may be presented in step 660. In one embodiment, the secondary authentication may be a key entry as illustrated in FIG. 4. In various other embodiments, alternative authentication methods may be implemented. While a keypad is discussed here (and illustrated in FIG. 4), a more complex keyboard may alternatively or additionally be presented to the user. In still other embodiments, non-touch authentication methods may be alternatively or additionally used, including audio or visual mechanisms, such as a passphrase spoken into a microphone of the user device or an image presented to the device. In one embodiment, the image may presented to the device's camera and may be a QR code or bar code. If the secondary authentication is passed in step 665, the user device's user interface may be configured according to user preferences and customization and access to secured portions of the user interface may be permitted. If the secondary authentication fails in step 665, guest settings from step 650 may be confirmed in 670 and access to the user device permitted with corresponding limitations to capabilities and access. In one embodiment, guest settings may limit access to non-secure applications. In still another embodiment, parental controls may be executed if guest settings are confirmed, restricting access to confidential information and/or to applications and information inappropriate for younger audiences. Guest settings may permit access only to gaming applications to allow children to use the device for entertainment. In another embodiment, guest settings may permit access only to a single page or applications. In various configurations, all applications on the page may be accessible or a subset of applications may be accessible.

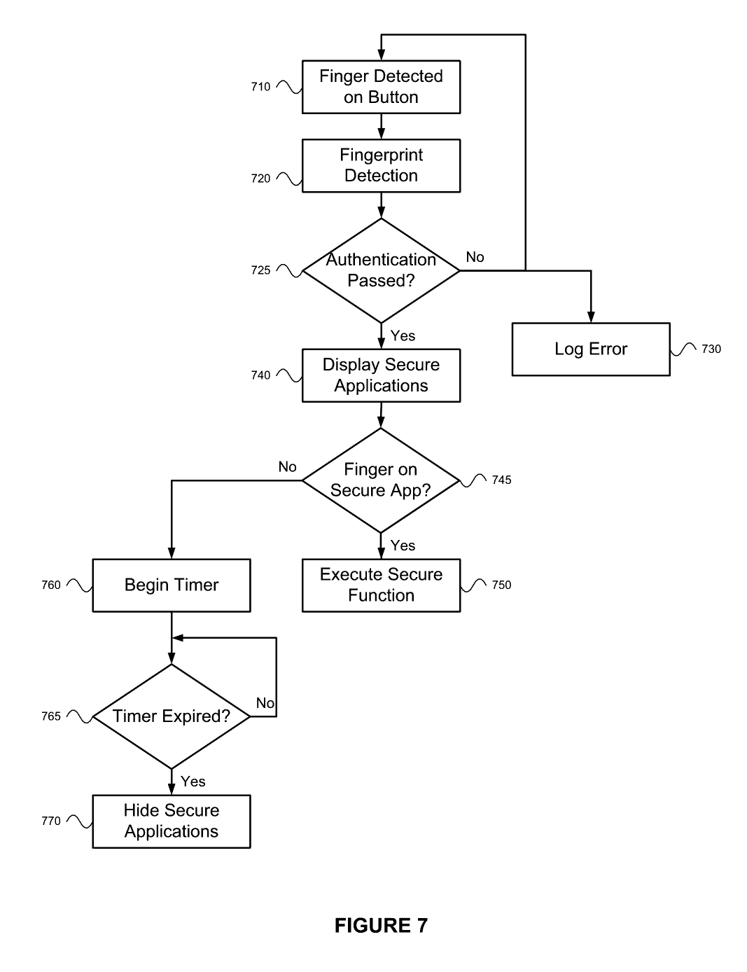

FIG. 7 illustrates a method 700 for accessing secure applications according to embodiments described with respect to FIGS. 3A and 3B. A finger may first be detected on the biometric sensor in step 710. Detection of the finger on the biometric sensor may be through detection with the biometric sensing electrodes themselves in one embodiment. In other embodiments, detection of a finger on the biometric sensor may be with a separate non-mechanical sensor or through a mechanical button. The separate, non-mechanical sensor may be a capacitance-based detection circuit. The capacitance based detection circuit may be integrated into the fingerprint detection circuit or it may be separate to the fingerprint detection circuit. The mechanical button may be coupled to the fingerprint detection circuit or it may be coupled to a separate controller. In still another embodiment, the mechanical button may provide power to or an interrupt signal to the fingerprint detection circuit. Once the fingerprint detection circuit is activated, a fingerprint image or data representative of/corresponding to a fingerprint may be captured in step 720. The capture fingerprint image or data may compared to a library of fingerprints or data in step 725. If the captured fingerprint image or data does not match any of the library of fingerprints or data, a log may be entered and the method may return to step 710. If the captured fingerprint image or data does match one of the library of fingerprints or data, at least one secure application may be displayed or altered to indicate that activation/execution of those applications is available. The location of a conductive object, such as the user's finger may then be compared to locations corresponding to the displayed secure applications in step 745. If the user's finger is detected over a location corresponding to a secure application, the secure application may be executed in step 750. If the user's finger is not detected over a location corresponding to a secure application, a timer may be started in step 760. If the timer expires in step 765, access to secure applications may be blocked, requiring the user to start the method from step 710 again. If the timer has not expired, method 700 may wait for the user to selected a secure application until the timer does expire.

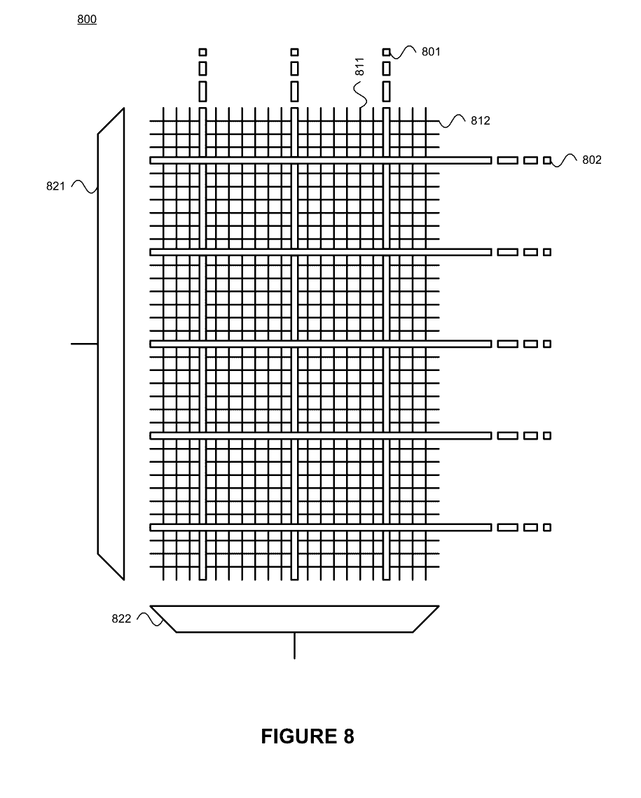

FIG. 8 illustrates a configuration of array 800 of touch detection electrodes and fingerprint imaging electrodes that may be alternately used for detecting the presence of a finger or other conductive object in a first mode and for imaging a fingerprint or generating fingerprint data in a second mode. For clarity of explanation, imaging a fingerprint may also be generating fingerprint data representative of the fingerprint. The fingerprint data may be an image or other information specific to a fingerprint in various embodiments. Array 800 may include first set of touch detection electrodes disposed as columns (801) and as rows (802). The columns 801 and rows 802 may be disposed with a pitch optimized for detection and location determination of a finger or conductive object. In one embodiment, each column electrode 801 may be 5 mm from neighboring column electrodes 801. Row electrodes 802 may be 5 mm from neighboring row electrodes 802. In other embodiments, other pitches may be used for column electrodes 801 and row electrodes 802. In still other embodiments, the pitches for column electrodes 801 may be different from the pitches of row electrodes 802. Array 800 may include a second set of fingerprint imaging electrodes disposed as columns (811) and rows (812). The columns 811 and rows 812 may be disposed with a pitch optimized for imaging a fingerprint. The pitch used for imaging a fingerprint may be considerably smaller than the pitch used for detecting and locating the position of a finger or other conductive object. In one embodiment, the pitch for fingerprint imaging electrodes may be 0.068 mm. While columns 801 and 811, and rows 802 and 812, are illustrated with a different thickness, this is for clarity of presentation. Electrodes used for finger detection and fingerprint imaging may be the same thickness or different in various embodiments. Additionally, electrodes of columns 801 and rows 802 may be used for fingerprint imaging with the electrodes of columns 811 and 812. In still another embodiment, any of the column electrodes 801 and 811 and row electrodes 802 and 812 may be used for finger detection. The connections of the electrodes may be determined by the configuration of multiplexors 821 and 822, which may be used to couple the electrodes to measurement circuits for finger detection and fingerprint imaging.

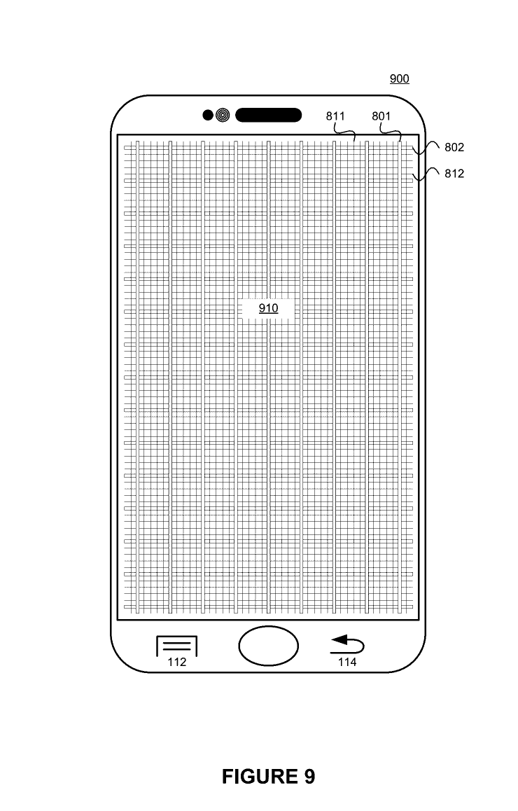

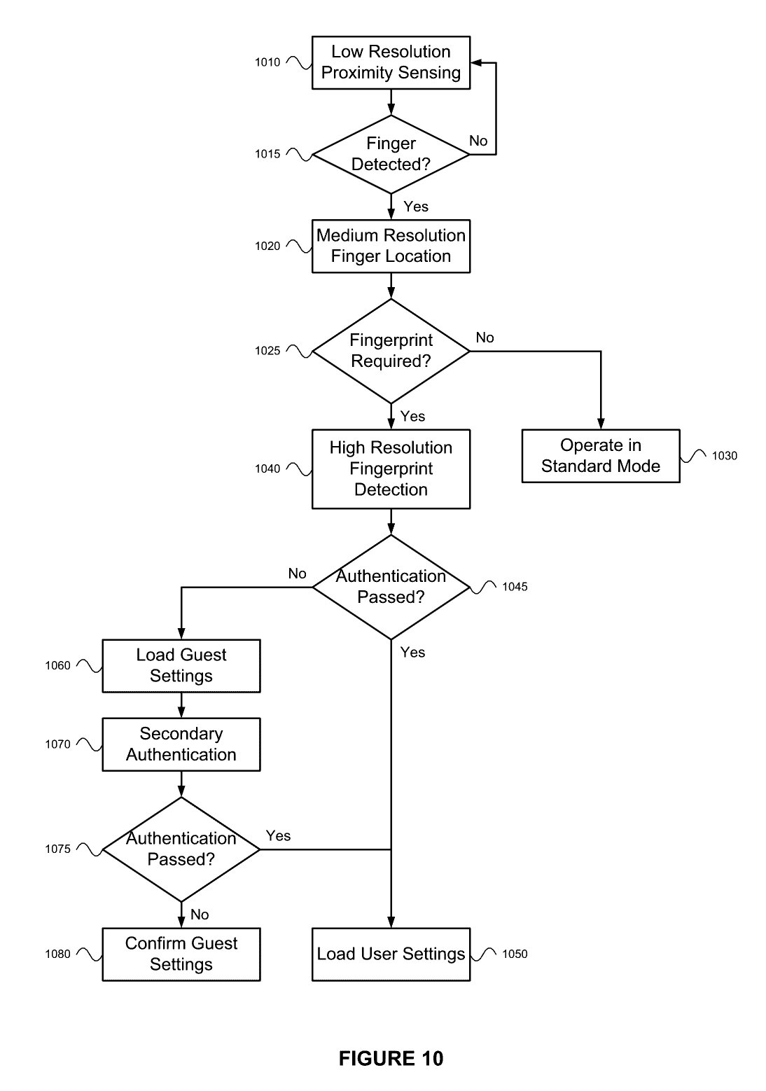

FIG. 9 illustrates an embodiment of a user device 900 (similar to user device 100 of FIG. 1) with the electrodes of FIG. 8 disposed over the entire panel. The electrodes of user device 900 may be used in various modes and in various combinations according to at least the uses in FIGS. 10-13 below.

FIG. 10 illustrates a method 1000 using electrodes similar to those shown in FIGS. 8 and 9. In a first mode, the panel of user device 900 is scanned at low-resolution to detect the proximity of a conductive object near the panel in step 1010. In the low-resolution proximity mode, a first set of electrodes may be scanned. Scanning of the electrodes may be capacitive, wherein a change in capacitance on or between the first set of electrodes is measured and compared to various thresholds. The first set of electrodes may be scanned in unison or separately, they may be scanned simultaneously or simultaneously, and they may be configured to be representative of the entire panel or a subsection of the panel. One goal of the low-resolution proximity mode may be to identify the presence of a user (through the identification of a conductive object) at a lower power. If a finger or other conductive object is not detected in step 1015, the low-resolution proximity mode is maintained and the panel may be scanned again. If a finger or other conductive object is detected in step 1015, the panel may be scanned in a second mode: medium resolution. In step 1020, the location of the finger or other conductive object may be determined using a second set of electrodes. The second set of electrodes may comprise rows and columns similar to columns 801 and rows 802 of FIG. 8. The second set of electrodes may have a pitch conducive to detection and position calculation of a finger or other conductive object. The position of the finger or other conductive object may then be compared to locations that may require biometric authentication (like a fingerprint) for further access. Locations that may require biometric authentication may be specific to secure applications on a page of the user interface or general to an entire page, based on the context of the user interface. In another embodiment, locations that require biometric authentication may be fixed and applications assigned to those locations may be gated by biometric authentication based on their position displayed on the user interface. This embodiment is similar to that illustrated in FIG. 3B. If biometric authentication (e.g. a fingerprint) is not required in step 1025, standard, non-secure operation of the user device may be executed in step 1030. If biometric authentication is required in step 1025, a third mode may be entered: high-resolution fingerprint detection.

In high-resolution fingerprint detection mode a higher number of the column and row electrodes may be scanned in step 1040 to provide an image of a fingerprint or data representative of a fingerprint in contact with the panel. In one embodiment, all of the electrodes may be scanned. In another embodiment, a periodic subset of the electrodes may be scanned, the periodic subset may still be representative of the entire panel. In still another embodiment, a subset of electrodes in a portion of the panel may be scanned. If the captured fingerprint image (or corresponding/representative fingerprint data) matches one of a library of fingerprints (or fingerprint data) corresponding to users permitted to access secured information of the user device in step 1045, the authenticated user's settings may be loaded and complete access to information and applications associated with the authenticated user may be permitted in step 1050. If the biometric authentication fails and the imaged fingerprint (or fingerprint data) does not match on of the library of fingerprints (or fingerprint data), guest settings may be loaded in step 1060. In one embodiment, the guest settings of step 1060 may exclude access to secure applications and other confidential information of the user device. Additionally, guest settings may cause the user device to operate in a factory-defined mode, absent any customization and personalization configured by authorized users. A secondary authentication may be presented in step 1070. In one embodiment, the secondary authentication may be a key entry as illustrated in FIG. 4. In various other embodiments, other authentication methods may be implemented. If the secondary authentication is passed in step 1075, the user device's user interface may be configured according to user preferences and customization and access to secured portions of the user interface permitted in step 1050. If the secondary authentication fails in step 1075, guest settings may be confirmed in 1080 and access to the user device permitted with limitations to capabilities and access.

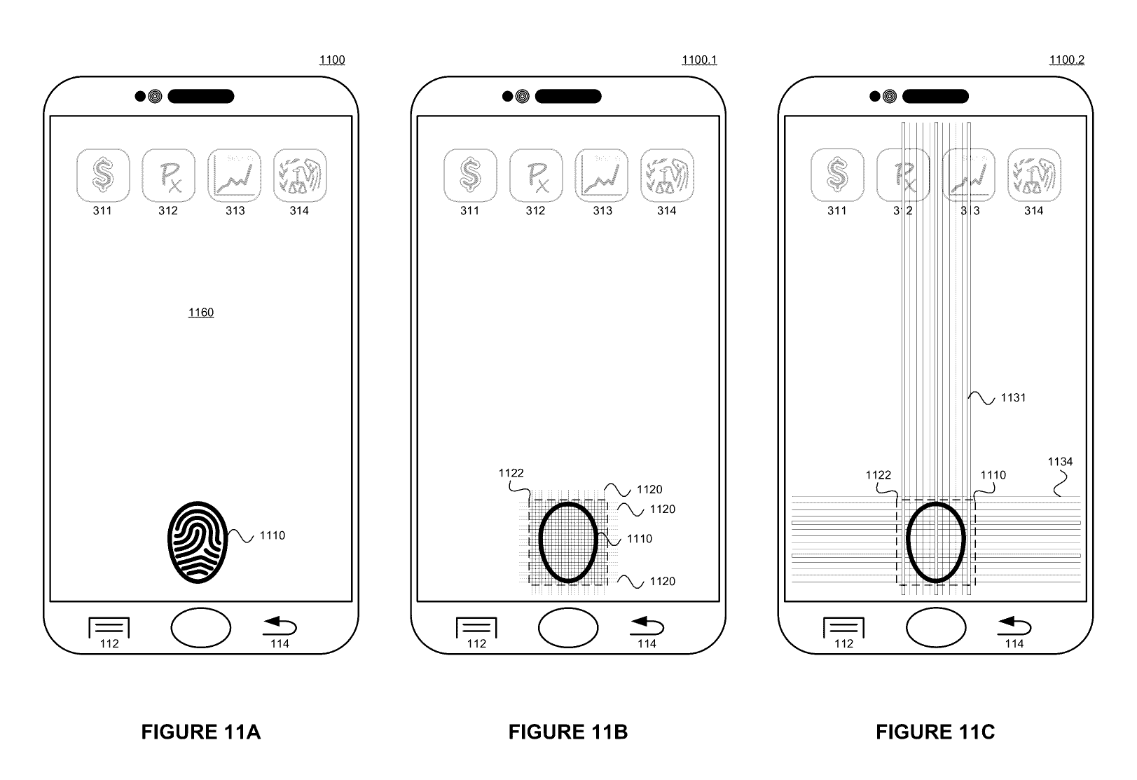

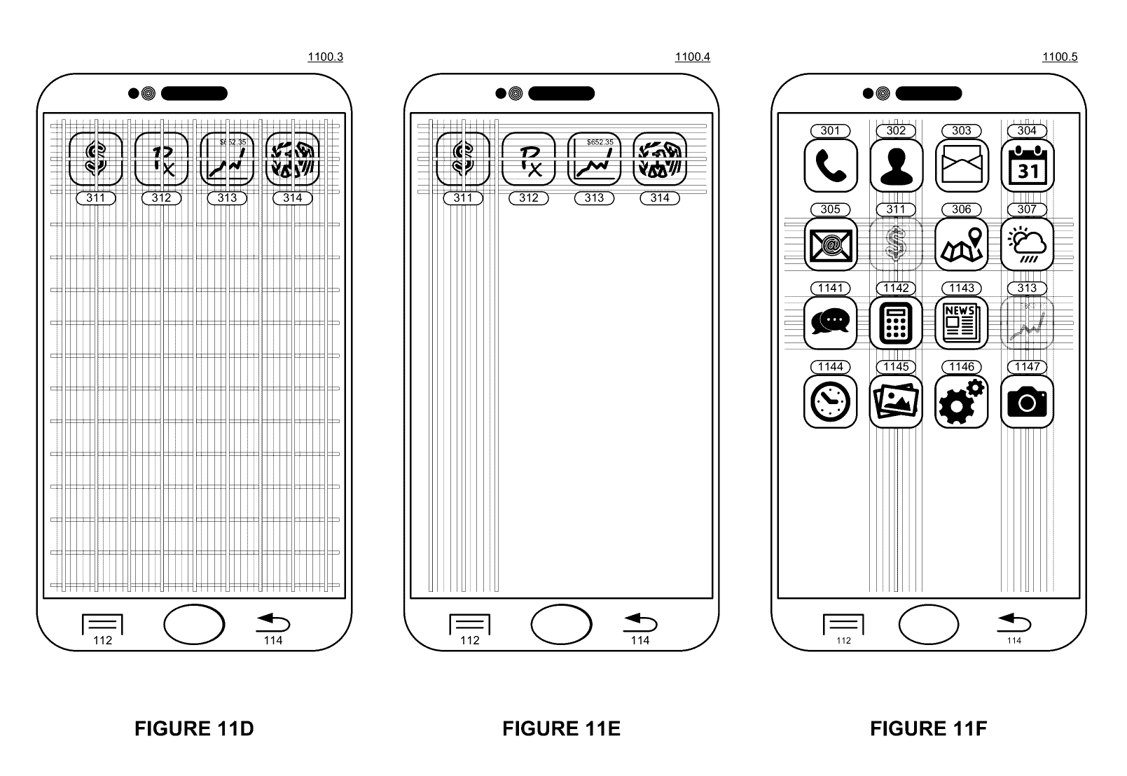

FIGS. 11A-F illustrate various embodiments of biometric authentication (fingerprint detection) integrated into a touch-enabled user interface.

FIG. 11A illustrates a user device 1100 with a page 1160 of secure applications 311-314 that may be accessed through an on-panel biometric authentication action. The biometric authentication requirement may be alerted to the user through a text display (as is illustrated in FIG. 3B) or it may be alerted to the user through an icon 1110 representative of required biometric entry.

FIG. 11B illustrates one embodiment or a user device 1100.1 with on-panel biometric authentication entry as illustrated in FIG. 11A. Electrodes 1120 which may be used to detect and image a fingerprint or generate fingerprint data may be disposed in a location 1122 corresponding to icon 1110. In one embodiment, fingerprint imaging electrodes 1120 may be separate from electrodes used to detect a touch from a conductive object on the touchscreen. Touch detection electrodes are not shown for clarity of presentation, but may be disposed as illustrated in FIG. 9. Fingerprint imaging electrodes 1120 may have a much finer pitch than the electrodes that are used to detect touches. In one embodiment, the electrodes used to detect a touch and fingerprint imaging electrodes may be comprised of different materials. For instance, the electrodes used to detect a touch may be comprised of indium tin oxide (ITO), while fingerprint imaging electrodes may be comprised of a metal. In another embodiment, the electrodes used to detect a touch and the electrodes used to image a fingerprint may be comprised of the same material.

FIG. 11C illustrates another embodiment of a user device 1100.2 with on-panel biometric authentication entry as illustrated in FIG. 11A. Fingerprint imaging electrodes may include electrodes use to detect a finger or other conductive objects, and additional electrodes disposed at a finer pitch in the area of fingerprint imaging (e.g., over the area corresponding to the icon). In this embodiment, touch detection electrodes 1131 may be disposed in a configuration similar to that discussed with respect to FIGS. 8 and 9, above. Fingerprint imaging electrodes 1134 may be limited to region 1122 corresponding to icon 1110. Fingerprint imaging electrodes 1134 may also be disposed across the panel as illustrated in FIG. 9 in another embodiment. In this embodiment, only the electrodes corresponding to icon 1110 may be “active” for fingerprint imaging or generation of fingerprint data.

FIG. 11D illustrates a user device 1100.3 with a page of secure applications 311-314 that may be accessed through an on-panel biometric authentication action. The biometric authentication requirement may be alerted to the user through a text display (as is illustrated in FIG. 3B) or it may be alerted to the user as faded or grayed out icons (as shown in FIGS. 3B and 3C). In one embodiment, fingerprint imaging or generation of fingerprint data may be enabled for all applications on the secured page. As long as the user places their finger on the application, the fingerprint may be imaged or data generated and the secure application executed if the fingerprint image/data matches at least one of a library of fingerprint images/data, as discussed with respect to FIG. 6.

FIG. 11E illustrates a user device 1100.4 with a page of secure applications that may be accessed through an on-panel biometric authentication action. The biometric authentication requirement may be alerted to the user through a text display (as is illustrated in FIG. 3B) or it may be alerted to the user as faded or grayed out icons. In one embodiment, fingerprint imaging or fingerprint data generation may be enabled for only the icon that is selected by the user. The enablement of fingerprint imaging or data generation may be by contact with or proximity to a location associated with the secure application displayed in the user interface and overlaid with electrodes. When a user selects a icon of a secure application on the page of secure applications, the fingerprint imaging/data generation electrodes corresponding to that icon may be activated and a fingerprint imaged or fingerprint data generated. Based on the user placing their finger on the application, the fingerprint may be imaged or fingerprint data generated and the secure application executed if the fingerprint image/data matches at least one of a library of fingerprint images/data, as described in FIG. 6.

FIG. 11F illustrates a user device 1100.5 with a page of mixed non-secure applications 301-307 and 1141-1147 and secure applications 311 and 313. When a user selects an icon of a secure application (311 or 313), the fingerprint imaging electrodes corresponding to that icon may be activated and a fingerprint imaged or fingerprint data generated. Based on the user placing their finger on the application, the fingerprint may be imaged or fingerprint data generated and the secure application executed if the fingerprint image/data matches at least one of a library of fingerprint images/data, as described in FIG. 6. If a non-secure application is selected by the user, fingerprint imaging or data generation is not initiated and the non-secure application is executed without any additional authentication. In one embodiment, the fingerprint imaging or data generation electrodes are not activated until the user places their finger on the icon for the secure applications. In another embodiment, the fingerprint imaging or data generation electrodes may be active whenever there is an icon corresponding to a secure application displayed.

Non-secure applications of FIG. 11F may include a telephone 301, a contact list 302, SMS messaging 303, a calendar 304, electronic mail (email) 305, maps 306, weather 307, chat (1141), a calculator (1142), news interface (1143), an alarm (1144), an image gallery (1145), settings (1146), or a camera (1147). Secure applications may include banking (311) or investments (313).

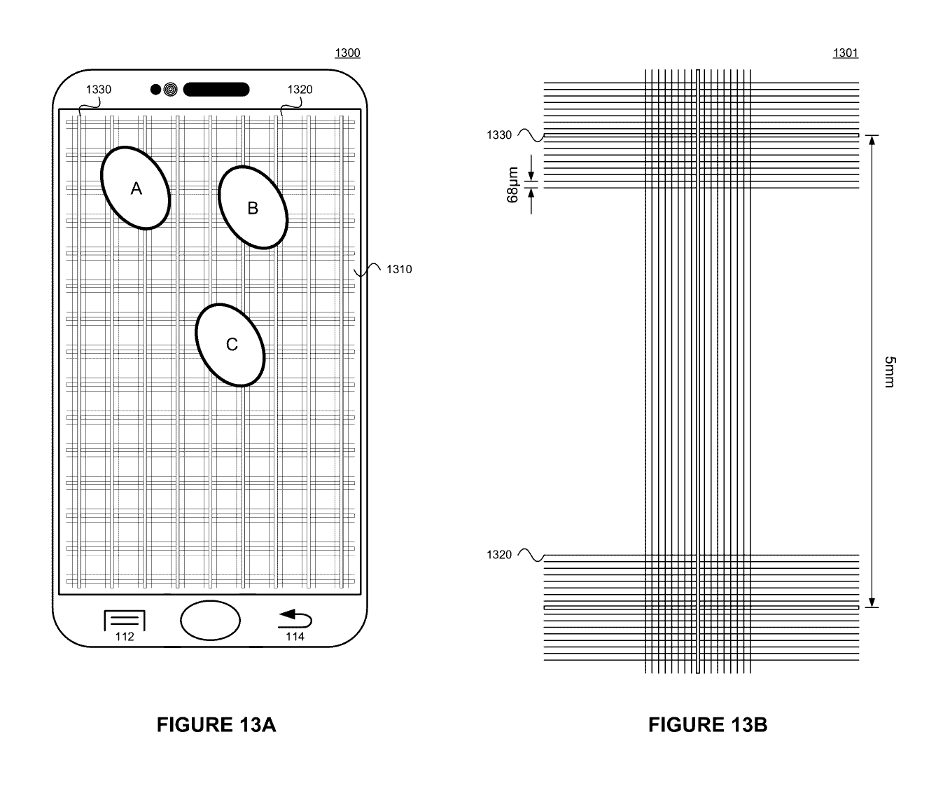

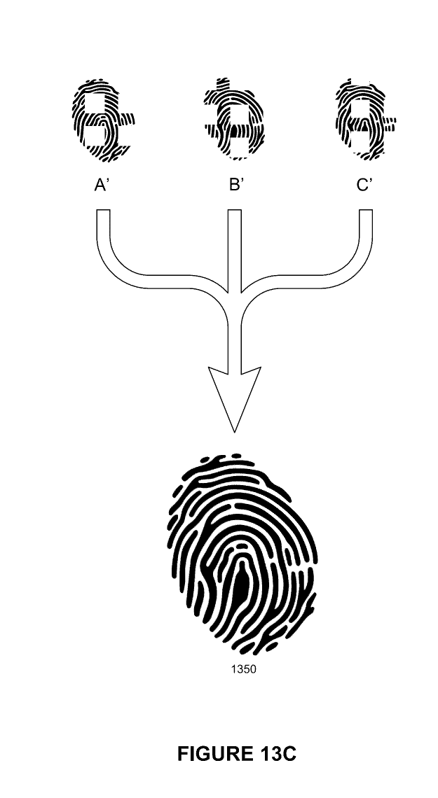

The embodiments of FIGS. 11B-F may allow for fingerprint imaging that is faster than if a fingerprint imaging operation were completed for the entire panel illustrated in FIGS. 9 and 13.

The embodiment of FIGS. 11C-F may use electrode configurations illustrated in FIGS. 9 and 13.

For clarity of explanation, not all of the electrodes that may be used to detect are illustrated in FIG. 11C-F. However, one of ordinary skill in the art would understand that the electrodes used to detect a touch would be disposed across the panel such that a finger or other conductive object may be detected anywhere that is necessary for operation of the user interface.

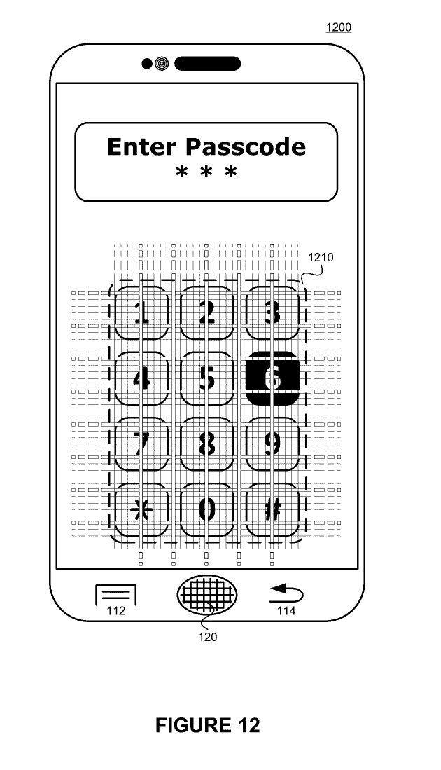

FIG. 12 illustrates an embodiment user device 1200 with dual authentication security. As a user enters a pass key and keypad 1210, fingerprint imaging or data generation may occur simultaneously. Fingerprint imaging or data generation may use electrodes as illustrated in FIGS. 9 and 13. The fingerprint image/data that is captured may be compared to a library of fingerprint images data. If the passkey and the fingerprint image data are both valid, the user device 1200 may be unlocked. If either or both of the authentication measures fail, user device 1200 may remain locked, or another authentication method may be presented to the user. The alternate authentication may be a pass phrase spoken into the user devices microphone or it may be a secondary fingerprint imaging action with the fingerprint imaging or data generation electrodes on the panel or a separate location like fingerprint detection module 120 of FIG. 1. The electrodes used for fingerprint imaging or data generation and touch detection (for key entry) may be disposed as described in FIGS. 8 and 9. In one embodiment, only the fingerprint imaging/data generation electrodes (811 and 812 of FIGS. 8 and 9) that correspond to keys on the keypad 1210 are active and configured to capture fingerprint images/data. In another embodiment, only those fingerprint imaging/data generation electrodes that correspond to keys that are to be pressed for authentication are active.

FIG. 13A illustrates a user device 1300 with an array 1310 of fingerprint imaging/data generation electrodes that is less than fully populated (partially-populated) across the entire panel. The fingerprint imaging/data generation electrodes 1320 may be deposited surrounding or adjacent to the electrodes used for detecting a touch (e.g., touch detection electrodes 1330). As touch detection electrodes 1330 may be disposed at a pitch that is much larger than fingerprint imaging/data generation electrodes 1320, there may be several fingerprint imaging/data generation electrodes 1320 on each side of the touch detection electrodes 1330, but still with partially populated distribution. The result may be a panel with fingerprint imaging/data generation electrodes 1320 and touch detection electrodes 1330 that cover the panel, but with gaps in that coverage. The gaps correspond to the coverage of the fingerprint imaging/data generation electrodes 1320. The partially populated distribution of the electrodes may allow for fewer electrodes and therefore fewer inputs on measurement circuits (e.g., touch controller 214 and fingerprint controller 224 of FIG. 2). The partially populated distribution may also allow for faster scanning as fewer inputs are measured.

While FIG. 13A illustrates only a single additional electrode for each touch detection electrode 1330, this is only for ease of description, and other embodiments may include multiple fingerprint imaging/data generation electrodes 1320 on each side of one or more of the touch detection electrodes.

FIG. 13B illustrates one embodiment of a portion of a partially populated panel 1301. Touch detection electrodes 1330 may be disposed with a pitch of 5 mm. On each side of touch detection electrodes 1330, there may be eight fingerprint imaging/data generation electrodes 1320 at a pitch of 0.068 mm. In this embodiment, 17 total electrodes are available for fingerprint imaging/data generation at each intersection of touch detection electrodes 1330. As stated with regard to FIGS. 8 and 9, touch detection electrodes 1330 and fingerprint imaging/data generation electrodes 1320 may have the same dimensions and materials or they may be different depending on design requirements. For the purposes of demonstration, touch detection electrodes 1330 and fingerprint imaging/data generation electrodes 1320 are illustrated with different widths. However, one of ordinary skill in the art would understand that this is merely illustrative and not intended to be at all limiting.

Returning to FIG. 13A, a user may touch the panel repeatedly (touches A, B, and C), interacting with different sections of the partially populated array 1310 and generating several images of or dataset corresponding to the same fingerprint that are each missing sections corresponding to areas of the array that do not have fingerprint imaging/data generation electrodes, or for which the fingerprint imaging/data generation electrodes are not active and part of a fingerprint imaging/data generation operation.

FIG. 13C illustrates the three fingerprint images/data sets (A′, B′, and C′) corresponding to the repeated touches (A, B, and C) of FIG. 13A. Each image/data set may be missing sections that were not detectable by the partially populated array. However, the combination of all three images/data set may produce a fingerprint image/data that can be matched to one of a library of fingerprint images/data. Stitching fingerprint images/data sets A′, B′, and C′ to create a single image/data may use standard image processing and assembling methods. These methods may include the identification of common features of each partial image/data set and aligning the partial images/data sets based on the those common features.

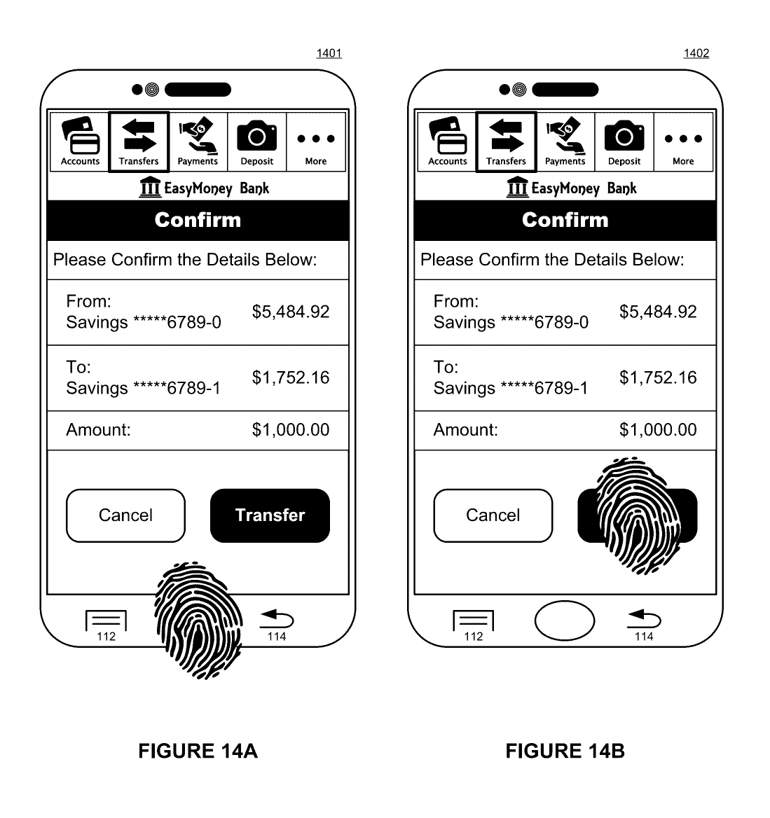

FIGS. 14A and 14B illustrate embodiments of in-application fingerprint detection using the electrodes and methods described.

FIG. 14A illustrates an application of user authentication 1401 for transferring money from one account to another. After the details of the transfer are entered, the mobile banking application may require the user to confirm their identity before completing the transaction. In the embodiment of FIG. 14A, the authentication may use a fingerprint detection module located off panel, similar to the fingerprint sensors shown in FIGS. 1 and 3B. In various embodiments, fingerprint imaging/data generation and biometric authentication with an off-panel sensor may start a timer that allows for confirmation icons on the touchscreen to be selected (within a specified time), fingerprint imaging data generation may serve as the confirmation (no additional selection of a confirmation icon), or fingerprint imaging data generation and biometric authentication may provide confirmation after an on-panel icon is selected.

FIG. 14B illustrates an application of user authentication 1402 for transferring money from on account to another using on-panel fingerprint imaging data generation as described with regard to FIGS. 8, 9, and 13A-C. In this embodiment, an image or corresponding data of a fingerprint may be captured from electrodes corresponding to a confirmation icon. If the fingerprint image/data matches one of library of fingerprint images/data and the confirmation icon is pressed, the money transfer action will be executed.

In the cases of both FIG. 14A and FIG. 14B, if the fingerprint image/data does not match one of a library of fingerprint images/data, additional authentication methods may be used as described in FIG. 5.

While a banking application is shown, one of ordinary skill in the art would understand that FIGS. 14A and 14B may apply to any applications with sensitive, secure information and for which the identity of the user may be necessary to complete an action within the applications.

In the above description, numerous details are set forth. It will be apparent, however, to one of ordinary skill in the art having the benefit of this disclosure, that embodiments of the present invention may be practiced without these specific details. In some instances, well-known structures and devices are shown in block diagram form, rather than in detail, in order to avoid obscuring the description.

Figures and associated descriptions are directed to a device resembling a mobile handset with a touchscreen. However, one of ordinary skill in the art may apply the techniques described to larger touch-enabled consumer devices, such as tablets and personal computers. Additionally, the techniques described may be applied to smaller touch-enabled consumer devices, such as watches, GPS unit, media players, etc. Furthermore, although consumer electronics are referenced above, secure entry for various functions may be used in home automation applications (home entry, appliances, HVAC control, lighting, and media control) as well as automotive applications.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “integrating,” “comparing,” “balancing,” “measuring,” “performing,” “accumulating,” “controlling,” “converting,” “accumulating,” “sampling,” “storing,” “coupling,” “varying,” “buffering,” “applying,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and circuits presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth above are merely exemplary. Particular implementations may vary from these exemplary details and still be contemplated to be within the scope of the present invention.

It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for accessing a secure function, the method including:
detecting a finger on a fingerprint data generation device;
generating data representative of a fingerprint of the finger;
comparing the data representative of the fingerprint to a library of fingerprint data stored in a memory;
if the data representative of the fingerprint matches fingerprint data in the library, displaying at least one icon representative of a secure function;
detecting a presence of a conductive object on a touch-sensitive array in a location corresponding to the at least one icon; and
executing a command corresponding to the secure function.

2. The method of claim 1, wherein the displaying of the at least one icon includes displaying the at least one icon for a period of time set by a counter, the method further comprising terminating displaying the at least one icon after the period of time set by the counter expires.

3. The method of claim 1, wherein the detecting the finger on the fingerprint data generation device comprises:
measuring a capacitance on a proximity electrode separate from a plurality of electrodes configured to generate data representative of the fingerprint;
comparing the capacitance on the proximity electrode to a threshold; and
detecting the finger on the fingerprint data generation device if the capacitance on the proximity electrode is greater than the threshold.

4. The method of claim 1, wherein the fingerprint imaging device is disposed on a mechanical button outside a display area of a display of a touch-sensitive interface.

5. The method of claim 1, wherein the fingerprint imaging device is disposed within a display area of the display of a touch sensitive interface.

6. The method of claim 5, wherein the fingerprint data generation device comprises a plurality of fingerprint data generation electrodes integrated with a plurality of touch detection electrodes of the touch sensitive interface.

7. The method of claim 1, wherein comparing the data representative of the fingerprint to a library of fingerprint data stored in a memory includes:
comparing the data representative of the fingerprint to a plurality fingerprint data in a plurality of libraries; and wherein
the displaying at least one icon representative of the secure function includes selecting the at least one icon based on which of the plurality of fingerprints data in the plurality of libraries matches the fingerprint the data representative of the fingerprint.

8. A touch-sensitive device comprising:
a display configured to display icons;
a first plurality of electrodes disposed on a first axis
a second plurality of electrodes disposed on a second axis, the second axis substantially perpendicular to the first axis;
a controller system including at least one controller, the controller system configured to:
measure capacitance between the first plurality of electrodes the second plurality of electrodes;
in a first mode, determine a position of a finger on a first group of the first plurality of electrodes; and
in a second mode, generate fingerprint data representative of a fingerprint on a second group of the first plurality of electrodes and the second plurality of electrodes,
wherein the second group of the first plurality of electrodes is selectively operable to determine the position of the finger and to generate fingerprint data, and
wherein a first resolution of the first group is substantially similar to a second resolution of the second group.

9. The touch-sensitive device of claim 8, wherein the at least one controller comprises:
a first controller configured to determine the position of a finger based on the at least one measured capacitance of the first group of electrodes; and
a second controller configured to generate data representative of the fingerprint based on at least one measured capacitance of the second group of electrodes.

10. The touch-sensitive device of claim 8, wherein the second group of electrodes includes at least one of the first group of electrodes.

11. The touch-sensitive device of claim 8, wherein the controller system is configured to compare the generated data representative of the fingerprint to a library of data and, if the generated data representative of the fingerprint matches at least one data in the library of data, execute a secure function of the touch-sensitive device.

12. The touch-sensitive device of claim 8, wherein the display is configured to display a plurality of icons, the plurality of icons corresponding to at least one secure application and at least one non-secure application.

13. The touch-sensitive device of claim 12, wherein the controller system is configured to execute the at least one secure application if the fingerprint data matches at least one fingerprint data in a library of fingerprint data.

14. The touch-sensitive device of claim 13, wherein the controller system is configured to execute the at least one non-secure applications responsive to a finger determined to be at a location corresponding to an icon for the non-secure application.

15. A biometric authentication device comprising;
a first plurality of electrodes disposed along a first axis, wherein the first plurality of electrodes comprises a first plurality of touch detection electrodes and a first plurality of fingerprint imaging electrodes;
a second plurality of electrodes disposed along a second axis substantially perpendicular to the first axis, wherein:
the second plurality of electrodes comprises a second plurality of touch detection electrodes and a second plurality of fingerprint imaging electrodes,
wherein the first and second pluralities of touch detection electrodes are disposed at a first pitch and the first and second pluralities of fingerprint imaging electrodes are disposed at a second pitch, and
wherein the first and second pluralities of fingerprint imaging electrodes are disposed such that gaps in the coverage of the first and second pluralities of fingerprint imaging electrodes exist on a surface of the biometric authentication device,
wherein the first and second pluralities of fingerprint imaging electrodes are selectively operable to determine the position of the finger and to generate fingerprint data,
wherein a first resolution of the first and second pluralities of touch electrodes is substantially similar to a second resolution the first and second pluralities of fingerprint imaging electrodes; and
a controller configured to create a fingerprint image from at least two contacts of the same finger on the surface of the biometric authentication device.

16. The biometric authentication device of claim 15, wherein the at least two contacts of the same finger are detected at different locations on the surface of the biometric authentication device.

17. The biometric authentication device of claim 16, wherein the different locations on the surface of the biometric authentication device correspond to at least two keys of a keypad.

18. The biometric authentication device of claim 17, wherein the controller is configured to compare the fingerprint image to a library of fingerprint images, compare a sequence of pressed keys to a passcode, and unlock the biometric authentication device if the fingerprint image matches a fingerprint in the library of fingerprint images and the sequence pressed keys matches the passcode.

19. The biometric authentication device of claim 15 further comprising a second controller configured to compare the fingerprint image to a library of fingerprint images.

20. The biometric authentication device of claim 19, further comprising a third controller configured to measure capacitances of the first and second pluralities of electrodes.
